(19) United States
(12) Patent Application Publication
(10) Pub. No.: US 2014/0255744 A1
(43) Pub. Date: Sep. 11, 2014

(54) JELLY ROLL OF BATTERY CELL FOR SECONDARY BATTERY

(71) Applicants: Gyu Sik Kim, Cheongwon-gun (KR); Young Suk Kim, Daejeon (KR); Hyung Bok Lee, Seoul (KR)

(72) Inventors: Gyu Sik Kim, Cheongwon-gun (KR); Young Suk Kim, Daejeon (KR); Hyung Bok Lee, Seoul (KR)

(73) Assignee: SK INNOVATION CO., LTD., Seoul (KR)

(21) Appl. No.: 14/352,123

(22) PCT Filed: Aug. 8, 2012
(86) PCT No.: PCT/KR2012/006286

§ 371 Date: Apr. 16, 2014

(30) Foreign Application Priority Data
Oct. 31, 2011 (KR) 10-2011-0111740

(51) Int. Cl. H01M 10/04

(52) U.S. Cl. CPC H01M 10/0431
USPC 429/94

(57) ABSTRACT

Provided is a secondary battery, and more particularly, is a jelly roll of a battery cell for a secondary battery having an electrode plate and a separator as basic components. The jelly roll of a battery cell for a secondary battery of the present invention enables the manufacture of a battery cell having improved insulation resistance, thereby improving the reliability of the battery cell, and the electrolyte wetting of the jelly roll, which may be deteriorated due to the contractile tube, can be facilitated.

### TECHNICAL FIELD

The present invention relates to a secondary battery, and more particularly to a jelly roll of a battery cell for a secondary battery having an electrode plate and a separator as basic components.

### BACKGROUND ART

Generally, a secondary battery may be recharged and manufactured as a large capacity battery. As a representative secondary battery, there may be a nickel cadmium battery, a nickel hydrogen battery, and a lithium ion battery, and so on. Among them, the lithium ion battery is receiving attention as the next generation power source due to excellent characteristics such as a long lifespan and high capacity thereof. Here, an operation voltage of the lithium secondary battery is 3.6V or higher. The lithium secondary battery is used as a power supply of a mobile electronic device or several lithium secondary batteries are connected in series, to thereby be used in a high-powered hybrid vehicle. The use of the lithium secondary battery is rapidly increasing since an operation voltage of the lithium secondary battery is three times higher than that of the nickel-cadmium battery or the nickel-metal hydride battery and energy density characteristics per unit weight of the lithium secondary battery is excellent.

The lithium secondary battery may be manufactured in various types, and the representative type thereof may be a cylinder type and a prismatic type that are mainly used in the lithium ion battery. A lithium polymer battery that has been spotlighted recently is manufactured in a flexible pouch type, and thus, the shape thereof is relatively free. In addition, the lithium polymer battery has excellent safety and a small weight, and thus is favorable in the slimming and weight-lightening of a mobile electronic device.

A battery cell of a secondary battery is composed of a battery part and a case for providing a space in which the battery part is contained. The battery part is called a jelly roll because it is like a shape obtained by winding jelly. The existing jelly roll has the following problems when it is inserted in a pouch type case.

Since a separator of the jelly roll is made in a thin film type, a portion of the separator positioned at the edge of the jelly roll may be caught in a sealing portion of the pouch type case when the jelly roll is inserted in the pouch case and then sealed. In this case, an insulation resistance between a sealing face of the pouch type case and an electrode tap may be deteriorated, resulting in degrading reliability of the battery cell. Moreover, when such the battery cell is used for a long time, corrosion may occur therein.

### DISCLOSURE

### [Technical Problem]

An object of the present invention is to provide a jelly roll of a battery cell for a secondary battery, capable of improving the deterioration in an insulation resistance, which is caused by catching a separator in a sealing part of a case, by wrapping the jelly roll with a contractile tube of an insulating material.

Another object of the present invention is to provide a jelly roll of a battery cell for a secondary battery, capable of facilitating electrolyte wetting of the jelly roll, which may be deteriorated due to the contractile tube, by forming a wetting hole in the contractile tube.

### [Technical Solution]

In one general aspect, there is provided a jelly roll of a battery cell for a secondary battery, the jelly roll including: a battery part including electrode plates arranged at a predetermined distance and a separator provided between the electrode plates; a cathode tap and an anode tap electrically connected with the electrode plates and protruded outwardly of an upper portion of the electrode plates; and a film wrapping the battery part.

The film may wrap an entire external surface of the battery part while only the cathode tap and the anode tap are exposed, and the film may be made in a tube shape of which an upper end and a lower end are opened.

The film may have at least one wetting hole penetrating the external surface of the battery part to thereby expose the battery part.

The film may be formed of a material that is shrunken by heat, to thereby be closely adhered to the battery part.

### [Advantageous Effects]

As set forth above, the jelly roll of a battery cell for a secondary battery of the present invention enables the manufacture of a battery cell having improved insulation resistance, thereby improving the reliability of the battery cell, and the electrolyte wetting of the jelly roll, which may be deteriorated due to the contractile tube, can be facilitated.

### DESCRIPTION OF DRAWINGS

The above and other objects, features and advantages of the present invention will become apparent from the following description of preferred embodiments given in conjunction with the accompanying drawings, in which:

FIG. 1 is a perspective view of a jelly roll according to the present invention;

FIG. 2 is an exploded perspective view of the jelly roll according to the present invention;

FIG. 3 is a plane view of another preferred embodiment of a battery cell according to the present invention;

FIG. 4 shows plane views of various examples of wetting holes according to present invention;

FIG. 5 is a cross-sectional view taken along the line AA′ of FIG. 1 according to a first preferred embodiment of the present invention;

FIG. 6 is a cross-sectional view taken along the line AA′ of FIG. 1 according to a second preferred embodiment of the present invention; and

FIG. 7 is a cross-sectional view taken along the line AA′ of FIG. 1 according to a third preferred embodiment of the present invention.

### DETAILED DESCRIPTION OF MAIN ELEMENTS

100: jelly roll
10: battery part
11: electrode plate
12: separator
13: cathode tap
14: anode tap
20: film
21: wetting holes

### BEST MODE

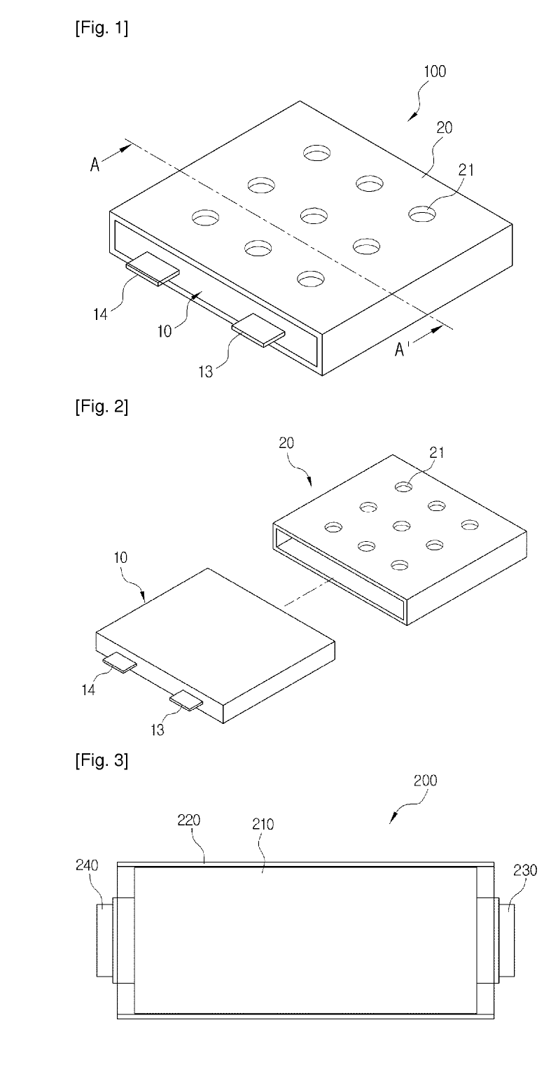

Referring to FIGS. 1 and 2, a jelly roll 100 according to a preferred embodiment of the present invention may include a battery part 10 and a film 20. A cathode tap 13 and an anode tap 14 are protruded from one lateral surface of the battery part 10. With respect to the present invention, a case where the cathode tap 13 and the anode tap 14 are formed on one lateral surface of the battery part 10 as shown in FIG. 1 will be mainly described, but the present invention is, of course, applied to a case where a cathode tap 230 and an anode tap 240 are formed on both lateral surfaces of a battery cell 200, respectively, as shown in FIG. 3.

The film 20 has such a size that the battery part 10 is easily inserted therein. After the battery part 10 is inserted in the film 20, the film 20 is shrunken by heat fusion to thereby be closely adhered to an external surface of the battery part 10.

Here, the battery part 10 is sealed together with electrolyte when being sealed in a case. If the battery part 10 is wrapped with the film 20, electrolyte wetting occurs only through an upper portion and a lower portion of the film 20, which may cause degradation in charging and discharging efficiency. Therefore the battery part 10 has the following constitution in order to facilitate electrolyte wetting.

Wetting holes 21 may be formed to penetrate the film 20. One or more wetting holes 21 may be formed in the external surface of the film 20 while the wetting holes 21 make rows and columns. Too many wetting holes 21 prevents the film 20 from functioning, and too few wetting holes 21 prevents the film 20 from performing a wetting function. Therefore, it is preferable to form appropriate number of wetting holes 21 depending on the capacity and size of the battery.

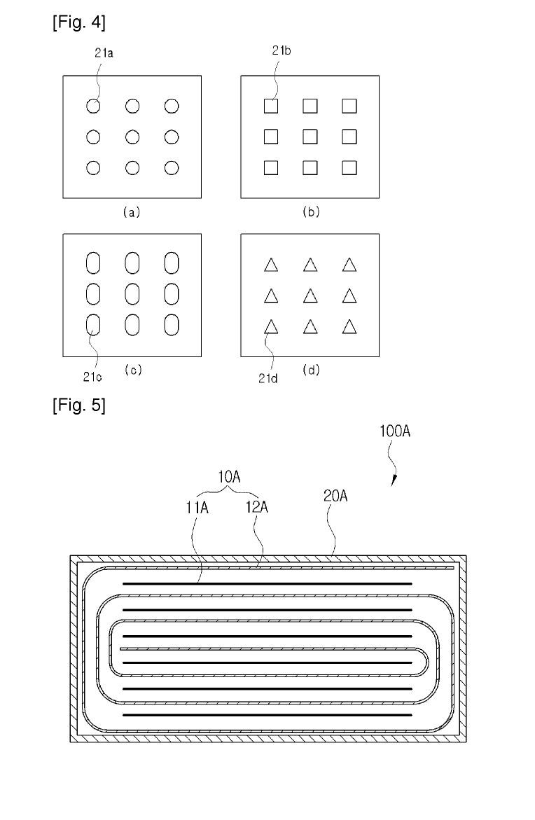

The wetting hole 21 may be, of course, formed in various shapes such as a circular shape 21a, a square shape 21b, an ellipse shape 21c, and a triangular shape 21d, as shown in FIG. 4.

Hereinafter, various preferred embodiments of the jelly roll 100 of the present invention for manufacturing a battery cell having an improved resistance will be described in detail with reference to the accompanying drawings.

### First Preferred Embodiment

Referring to FIG. 5, a jelly roll 100A according to a first preferred embodiment of the present invention may include a battery part 10A including electrode plates 11A and a separator 12A, and a film 20A.

The battery part 10A may be constituted in a type where a plurality of electrode plates 11A are laminated. With respect to the electrode plates 11A, cathode plates and anode plates may be alternately laminated. Here, the separator 12A may be inserted between the cathode plate and the anode plate. A manufacturing method for the above constitution is as follows.

The separator 12A is disposed in a length direction thereof, and then the electrode plates 11A are arranged on an upper surface of the separator 12A at a predetermined distance. Then, the separator 12A is wound by using one electrode plates 11A as a base unit, to thereby complete the battery part 10A. The respective electrode plates 11A are electrically connected with a cathode tap and an anode tap.

A lateral surface of the battery part 10A shows a structure where the separator 12A is folded several times. Since the separator 12A is in a thin film type, the separator 12A may be caught in a sealing surface of the case when the battery part 10A is inserted in the case and then sealed. In order to prevent the above disadvantage, the battery part according to the first preferred embodiment of the present invention has a characteristic constitution as follows.

The film 20A wraps the battery part 10A. The film 20A is made in a tube type of which an upper portion and a lower portion are opened, and may be made in a contractile tube type, to thereby facilitate close adherence to the battery part 10A after the battery part 10A is inserted in the film 20A. A shape of the film 20A may be similar to a shape of an external surface of the battery part 10A so that the battery part 10A is easily inserted in the film 20A. The battery part 10A is shown in a hexahedral shape on the drawing, but a cross section thereof is generally an elliptical shape, and thus, a cross section of the film 20A may be an elliptical shape.

### Second Preferred Embodiment

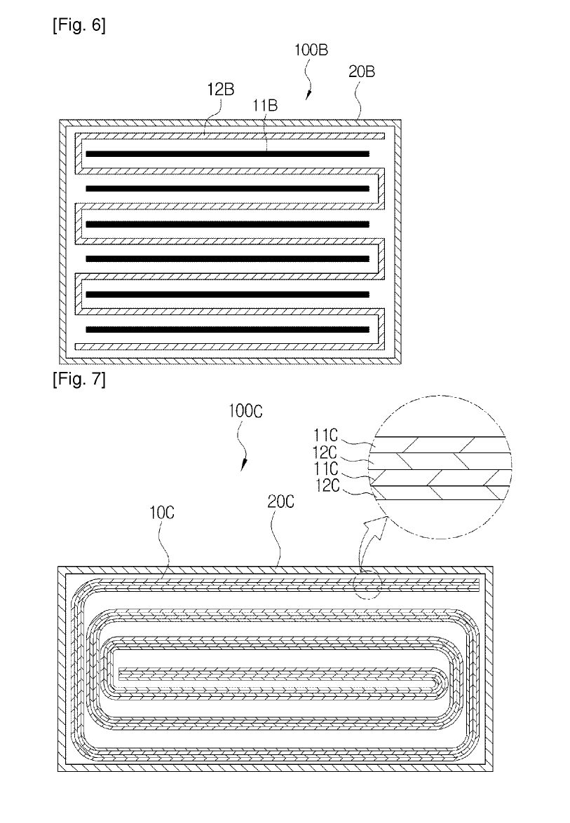

Referring to FIG. 6, a jelly roll 100B according to a second preferred embodiment of the present invention may include a battery part 10B including electrode plates 11B and a separator 12B, and a film 20B.

The battery part 10B may be constituted in a type where a plurality of electrode plates 11B are laminated. With respect to the electrode plates 11B, cathode plates and anode plates may be alternately laminated. Here, the separator 12B may be inserted between the cathode plate and the anode plate. A manufacturing method for the above constitution is as follows.

The separator 12B may be bent in a zigzag type to thereby make multiple layers, and each of the electrode plates 11B may be laminated between the layers of the separator 12B. Here, with respect to the electrode plates 11B, cathode plates and anode plates may be alternately laminated. The respective electrode plates 11B of the battery part 10B are electrically connected with a cathode tap and an anode tap.

The other constitutions of the film 20B are the same as those of the film 20A according to the first preferred embodiment as described above, and thus, detail descriptions thereof will be omitted.

### Third Preferred Embodiment

Referring to FIG. 7, a jelly roll 100C according to a third preferred embodiment of the present invention may include a battery part 10C including electrode plates 11C and separators 12C, and a film 20C.

The battery part 10C may be constituted in a type where a plurality of electrode plates 11C are laminated. With respect to the electrode plates 11C, cathode plates and anode plates may be alternately laminated. Here, the separator 12C may be inserted between the cathode plate and the anode plate. A manufacturing method for the above constitution is as follows.

The electrode plates 11C are lengthily disposed in a length direction, and the separators 12C are laminated thereon such that each of the electrode plates 11C, which are made of the cathode plate and the anode plate, is positioned between the separators 12C. Then, the laminate where the electrode plates 11C and the separators 12C are laminated in a length direction is wound to thereby constitute the battery part. As an example of lamination, a separator, an anode plate, a separator, and a cathode plate are sequentially laminated, and then wound.

The other constitutions of the film 20C are the same as those of the film 20A according to the first preferred embodiment as described above, and thus, detail descriptions thereof will be omitted.

The technical spirit of the present invention should not be construed by limiting present invention to the above-mentioned preferred embodiments. The application range thereof is of course varied, and various modifications thereof may be made by those skilled in the art without departing from the gist of the present invention. Therefore, as long as these modifications and changes are apparent to those skilled in the art, they are included in the protective scope of the present invention.

1. A jelly roll of a battery cell for a secondary battery, the jelly roll comprising:
a battery part including electrode plates arranged at a predetermined distance and a separator provided between the electrode plates;
a cathode tap and an anode tap electrically connected with the electrode plates and protruded outwardly of an upper portion of the electrode plates; and
a film wrapping the battery part.

2. The jelly roll of claim 1, wherein the film wraps an entire external surface of the battery part while only the cathode tap and the anode tap are exposed.

3. The jelly roll of claim 1, wherein the film is made in a tube shape of which an upper end and a lower end are opened.

4. The jelly roll of claim 1, wherein the film has at least one wetting hole penetrating the external surface of the battery part to thereby expose the battery part.

5. The jelly roll of claim 1, wherein the film is formed of a material that is shrunken by heat, to thereby be closely adhered to the battery part.
